(19) United States
(12) Patent Application Publication
(10) Pub. No.: US 2017/0190029 A1
(43) Pub. Date: Jul. 6, 2017

(54) RATCHETING FLEX-WRENCH SYSTEM

(71) Applicant: Julio Cuesta, Murrieta, CA (US)

(72) Inventor: Julio Cuesta, Murrieta, CA (US)

(21) Appl. No.: 15/396,806

(22) Filed: Jan. 2, 2017

Related U.S. Application Data
(60) Provisional application No. 62/387,690, filed on Jan. 4, 2016.
(60) Provisional application No. 62/387,700, filed on Jan. 4, 2016.

(51) Int. Cl. B25B 23/00; B25B 13/46

(52) U.S. Cl. CPC B25B 23/0028; B25B 13/462; B25B 23/0035

(57) ABSTRACT

A ratcheting flex-wrench device. The device includes an elongated handle having opposing ends, each opposing end having an integral yoke and a tool head pivotally coupled to the yoke. Each tool head includes an annular socket member rotationally disposed within the tool head. The annular socket member is configured to engage a Torx external hexalobular fitting of a workpiece. The annular socket member includes internal contours matching the outer lobe contours of the Torx external hexalobular fitting. Each tool head includes a ratchet mechanism configured to provide one-way directional rotation of the annular socket member.

### CROSS-REFERENCE TO RELATED APPLICATION

The present application is related to and claims priority to U.S. Provisional Patent Application No. 62/387,700 filed Jan. 4, 2016, and is related to and claims priority to U.S. Provisional Patent Application No. 62/387,690 filed Jan. 4, 2016, which applications are incorporated by reference herein in their entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

1. Field of the Invention

The present invention relates generally to the field of one-way drive (ratcheting) tools of existing art and more specifically relates to one-way drive (ratcheting) tools having a handle and one or more articulated tool heads.

2. Description of Related Art

There are many threaded-fastener drive formats in use today. One commonly-used format is the Hexgon Head format, often abbreviated HH or HX. Despite its popularity, the HH head format has inherent design weaknesses. For example, the 60-degree drive angle of the HH format is relatively inefficient for torque transfer. In addition, the HH format concentrates the most stress at the corners of the drive tool, which can cause the tool surfaces to quickly wear or in some cases fail.

The hexalobular “Torx” format was developed as a functionally superior and cost-effective alternative to the Hex format and related designs. The broad contact surface of the Torx format provides greater engagement between the driver and the fastener lobes, which spreads the driving forces over a larger surface area. In addition, the 15-degree drive angle of the Torx format provides more efficient torque transfer resulting in extended tool life.

Torx fasteners are manufactured to very critical, proprietary tolerances. Unfortunately, some tool manufacturers have attempted to produce universal tools advertised to work with multiple fastener formats, including, Torx, Square, 12-Point, 6-Point, etc. Because these “universal” tools do not fit the fasteners precisely, they often strip the fasteners during use.

A need clearly exists for new systems to overcome the above-mentioned problems, such systems including improved tools incorporating drivers precisely matched to the Torx fastener format, that are more convenient, more reliable, and less expensive than those currently in use.

An example of the above-noted “universal”-type tool is described in U.S. Pat. No. 8,459,151 to Wang et al. The device of Wang et al. relates to a ratcheting socket wrench and sockets. The described ratcheting socket wrench and sockets includes a wrench for action on a work piece. The wrench is a box end socket wrench. The socket wrench has an elongated handle with a box head. The box head has a top and a bottom surface and an inner wall defining an inner aperture. The inner wall is shaped to receive the work piece and has a receiving groove spaced apart from the top surface of the box head to receive a biased member. The biased member extends into the inner aperture of the box head to releasably secure the work piece. When the work piece is inserted in the inner aperture of the box head, the work piece sits flush with the corresponding top and bottom surface of the box head of the wrench. The device of Wang et al. fails to disclose or suggest the particular combination of structures and arrangements of the presently disclosed system.

### BRIEF SUMMARY OF THE INVENTION

In view of the foregoing disadvantages inherent in the known one-way drive (ratcheting) tools having a handle and one or more articulated tool heads art, the present disclosure provides a novel ratcheting flex-wrench system. The general purpose of the present disclosure, which will be described subsequently in greater detail, is to provide a ratcheting flex-wrench system.

In accordance with a preferred embodiment hereof, this invention provides a ratcheting flex-wrench device, the device including; an elongated handle having opposing ends, each opposing end having an integral yoke, a tool head pivotally coupled to the integral yoke, the tool head including an annular socket member rotationally disposed within the tool head, the annular socket member configured to engage a Torx external hexalobular fitting of a workpiece, the annular socket member having internal contours matching the outer lobe contours of the Torx external hexalobular fitting and enabling a transfer of force between the tool head and the lobe surfaces of the Torx external hexalobular fitting, and a ratchet mechanism configured to provide one-way directional rotation of the annular socket member.

Moreover, it provides such a ratcheting flex-wrench device wherein the ratchet mechanism includes a switch mechanism enabling user-actuated reversals of the one-way directional rotation of the annular socket member. Additionally, the annular socket member is configured to engage a Torx external hexalobular fitting having a standard size of between E4 and E44. Also, the annular socket member has a first socket face and a second socket face opposite first socket face, the tool head has a first tool-head face and a second tool-head face opposite the first tool-head face, and at least one of the first socket face and the second socket face are justified with the first tool-head face.

In addition, it provides such a ratcheting flex-wrench device wherein at least one of the first socket face and the second socket face project outwardly beyond the second tool-head face. The ratcheting flex-wrench device further includes a head-angle retaining mechanism configured to retain the tool head at a user-selectable angular position relative to the elongated handle, wherein the head-angle retaining mechanism includes a detent-engagement hub integral with the tool head, the detent-engagement hub having a plurality of arcuately-arranged grooves oriented in substantially-parallel relationship with a pivot axis of the tool head, and a user-operable detent mechanism disposed within the integral yoke. More specifically, the user-operable detent mechanism has a hub-engaging detent member configured to engage the grooves of the detent-engagement hub.

Furthermore, it provides such a ratcheting flex-wrench device wherein the hub-engaging detent member includes a spherical detent having a biasing spring configured to bias the spherical detent to a position releasably engaging the grooves of the detent-engagement hub. Even further, the user-operable detent mechanism includes, interoperating with the hub-engaging detent member, a user-actuated locking and release button configured to move the hub-engaging detent member between a locking position engaging the grooves and an unlocked position disengaged from the grooves. In this arrangement, the pivotal rotation of the tool head relative to the elongated handle is prevented when the hub-engaging detent member is in the locked position, and wherein the pivotal rotation of the tool head relative to the elongated handle is enabled when the hub-engaging detent member is in the unlocked position.

In addition, it provides such a ratcheting flex-wrench device wherein the head-angle retaining mechanism further includes a shouldered pin slidably disposed in an axially-extending bore of the integral yoke, and a biasing spring disposed within the axially-extending bore and operably engaged with the shouldered pin, wherein the shouldered pin includes an enlarged head portion and an elongated tail portion extending outwardly therefrom, wherein the enlarged head portion forms the hub-engaging detent member, wherein the elongated tail portion has a cross-sectional dimension smaller than that of the enlarged head portion, wherein the biasing spring is configured to bias the enlarged head portion to the locked position engaging the grooves of the detent-engagement hub, and wherein manually depressing the user-actuated locking and release button translates the shouldered pin to the unlocked position disengaging the enlarged head portion from the grooves and positioning the elongated tail portion adjacent the detent-engagement hub.

Additionally, the axially-extending bore includes a bore axis in parallel orientation with the pivot axis of the tool head. Also, the head-angle retaining mechanism further includes a spherical detent movably positioned adjacent the detent-engagement hub, a push bar slidably disposed in an axially-extending bore of the integral yoke, and a biasing spring disposed within the axially-extending bore and operably engaged with the push bar, wherein the push bar includes a sloping wall portion extending axially along the push bar and arrange to be in contact with the spherical detent, wherein the spherical detent includes the hub-engaging detent member, wherein the biasing spring is configured to bias the sloping wall portion to a position urging the spherical detent to the locked position engaging the grooves of the detent-engagement hub, and wherein manually depressing the user-actuated locking and release button translates the push bar to locate the sloping wall portion in a position allowing the spherical detent to move to the unlocked position disengaging the spherical detent from the grooves. In addition, it provides such a ratcheting flex-wrench device wherein the axially-extending bore includes a bore axis in parallel orientation with the pivot axis of the tool head.

In accordance with another preferred embodiment hereof, this invention provides a ratcheting flex-wrench device, the device including; a handle having opposing handle ends, each handle end including a tool head pivotally coupled to the handle, the tool head including an annular socket member rotationally disposed within the tool head, the annular socket member configured to engage a Torx external hexalobular fitting of a workpiece, the annular socket member having internal contours matching the outer lobe contours of the Torx external hexalobular fitting and enabling a transfer of force between the tool head and the lobe surfaces of the Torx external hexalobular fitting, a ratchet mechanism configured to provide one-way directional rotation of the annular socket member, a head-angle retaining mechanism configured to retain the tool head at a user-selectable angular position relative to the handle. In this arrangement, the head-angle retaining mechanism includes a detent-engagement hub integral with the tool head, the detent-engagement hub having a plurality of arcuately-arranged grooves oriented in substantially-parallel relationship with a pivot axis of the tool head, a user-operable detent mechanism disposed within the handle end, the user-operable detent mechanism having a hub-engaging detent member configured to engage the grooves of the detent-engagement hub, and interoperating with the hub-engaging detent member, a user-actuated locking and release button configured to move the hub-engaging detent member between a locking position engaging the grooves and an unlocked position disengaged from the grooves. In this arrangement, the pivotal rotation of the tool head relative to the handle is prevented when the hub-engaging detent member is in the locked position and the pivotal rotation of the tool head relative to the handle is enabled when the hub-engaging detent member is in the unlocked position. In addition, the ratchet mechanism includes a switch mechanism enabling user-actuated reversals of the one-way directional rotation of the annular socket member.

Furthermore, it provides such a ratcheting flex-wrench device where the ratcheting flex-wrench device is arranged as a kit, the kit including a plurality of ratcheting flex-wrench devices each one including a size differing from the others. Even further, it provides such a ratcheting flex-wrench device wherein the plurality of ratcheting flex-wrench devices comprise sizes ranging between E4 and E44.

In accordance with another preferred embodiment hereof, this invention provides a ratcheting flex-wrench device, the device including; a handle having two opposing ends, the handle configured to assist user handling of the ratcheting flex-wrench device, each opposing end including a fitting engager configured to engage a Torx external hexalobular fitting of a workpiece, the fitting engager assisting the transfer torque forces between the handle and the workpiece, a housing configured to house the fitting engager, a ratchet mechanisms providing one-way directional rotation of fitting engager within the housing, a pivot coupler configured to pivotally couple the housing to the handle, and a head-angle retainer configured to retain the housing at a user-selectable angular position relative to the handle.

Even further, it provides such a ratcheting flex-wrench device wherein the head-angle retainer includes a releasable lock configured to releasably lock the housing in a user-selectable angular position relative to the handle. Moreover, the releasable lock includes a detent-engagement hub integral with the housing, the detent-engagement hub having a plurality of arcuately-arranged grooves oriented in substantially-parallel relationship with a pivot axis of the housing, and a user-operable detent mechanism disposed within the handle, the user-operable detent mechanism having a hub-engaging detent member configured to engage the grooves of the detent-engagement hub. Even further, it provides such a ratcheting flex-wrench device wherein the ratchet mechanism includes a switch mechanism enabling user-actuated reversals of the one-way directional rotation of the annular socket member.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a ratcheting flex-wrench system, constructed and operative according to the teachings of the present disclosure.

FIG. 1 is a perspective view of a ratcheting flex-wrench device of the ratcheting flex-wrench system during an ‘in-use’ condition, according to an embodiment of the disclosure.

FIG. 2 is a perspective view of the ratcheting flex-wrench device of FIG. 1, according to an embodiment of the present disclosure.

FIG. 3 is a front view of the ratcheting flex-wrench device of FIG. 1, according to an embodiment of the present disclosure.

FIG. 4 is a side view of the ratcheting flex-wrench device of FIG. 1, according to an embodiment of the present disclosure.

FIG. 5 is a partial side view of the ratcheting flex-wrench device of FIG. 1, illustrating a pivoting tool head of the device.

FIG. 6 is a partial front view of an alternate ratcheting flex-wrench device of the ratcheting flex-wrench system, according to another embodiment of the present disclosure.

FIG. 7 is a partial front view of an alternate ratcheting flex-wrench device of the ratcheting flex-wrench system, according to an additional embodiment of the present disclosure.

FIG. 8 is a top view of the ratcheting flex-wrench device of FIG. 1, according to an embodiment of the present disclosure.

FIG. 9 is a top view of an alternate ratcheting flex-wrench device of the ratcheting flex-wrench system, according to an additional embodiment of the present disclosure.

FIG. 10 is a partial front view of a locking ratcheting flex-wrench device of the ratcheting flex-wrench system, according to another embodiment of the present disclosure.

FIG. 11 is a partial side view of the locking ratcheting flex-wrench device of FIG. 10, according to an embodiment of the present disclosure.

FIG. 12 is a front view, in partial section, of the locking ratcheting flex-wrench device of FIG. 10 in a locked condition, according to an embodiment of the present disclosure.

FIG. 13 is a side view, in partial section, of the locking ratcheting flex-wrench device of FIG. 10, according to an embodiment of the present disclosure.

FIG. 14 is a front view, in partial section, of the locking ratcheting flex-wrench device of FIG. 10 in an unlocked condition, according to an embodiment of the present disclosure.

FIG. 15 is a side view, in partial section, of the locking ratcheting flex-wrench device of FIG. 10 adjusted to have a new tool-head angle, according to an embodiment of the present disclosure.

FIG. 16 is a front view, in partial section of an alternate locking ratcheting flex-wrench device of the ratcheting flex-wrench system, according to another embodiment of the present disclosure.

FIG. 17 is a front view, in partial section of a head-angle retainer of an alternate ratcheting flex-wrench device of the ratcheting flex-wrench system, according to another embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a one-way drive (ratcheting) tools having a handle and one or more articulated tool heads and more particularly to a ratcheting flex-wrench system as used to improve ratcheting wrenches having a handle and one or more articulated tool heads containing E-Torx drive sockets.

Generally, the E-Torx Flex wrench includes a special E-Torx socket type, which has not yet been developed as a pivoting-head wrench. With a traditional wrench it is difficult to get into hard to reach places, but with the pivoting-head wrench a used can reach any angle needed. The spring-loaded locking pin allows the head to swivel and lock into the exact angle needed by the user. This way, when the user is trying to torque the wrench up, or down, the head stays in one place and won't move during use like customary socket wrenches. The thick, elongated, handle ensures a firm proper grasp and the length needed to get into areas that are further back and out of reach. The socket also extends out just beyond the face of the head to make sure it is a more solid grip and the material won't strip as easily like other wrenches. This wrench provides advanced features while offering durability and reliability. Anyone who believes in having the proper tool for the job will appreciate the usefulness of having the presently-disclosed ratcheting flex-wrench in their tool set to make working with E-Torx fasteners faster and easier.

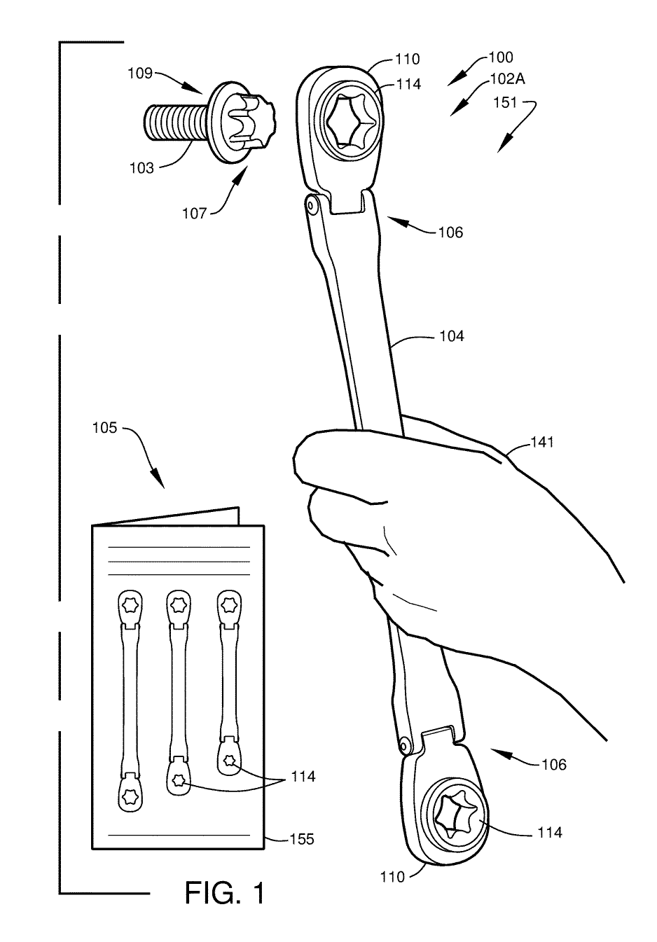

Referring now more specifically to the drawings by numerals of reference, there is shown in FIGS. 1-17, various embodiments of a ratcheting flex-wrench system 100. FIG. 1 shows a ratcheting flex-wrench device 102A of the ratcheting flex-wrench system 100 during an ‘in-use’ condition 151, according to the present disclosure. Here, the ratcheting flex-wrench device 102A may be beneficial for use by a user 141 to remove or install a mechanical fastener 103 or other workpiece 109 having an external Torx head 107.

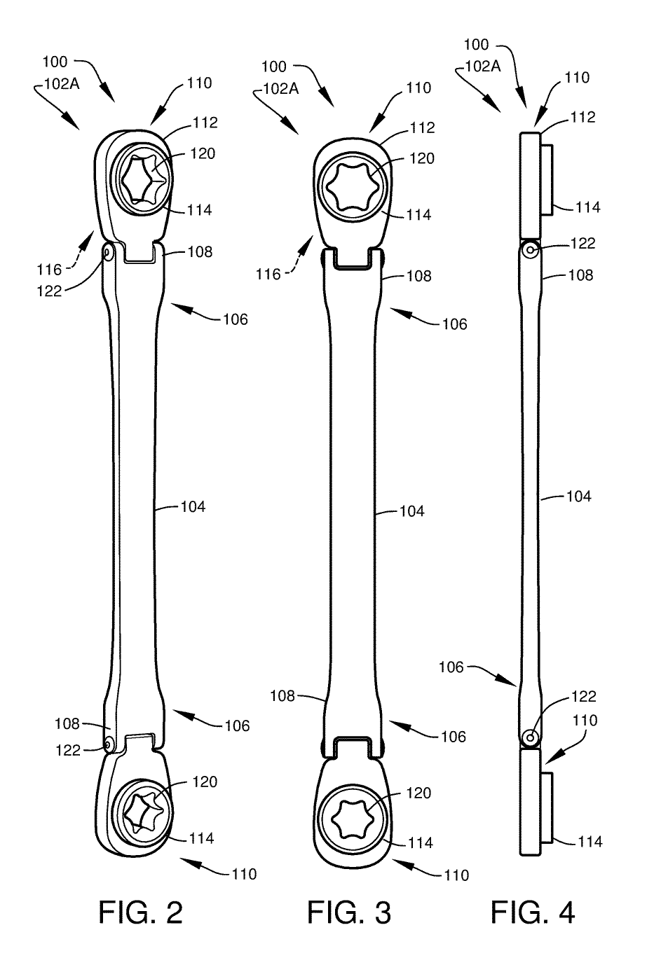

FIG. 2 is a perspective view of the ratcheting flex-wrench device 102A of FIG. 1. FIG. 3 is a front view of the ratcheting flex-wrench device 102A of FIG. 1. FIG. 4 is a side view of the ratcheting flex-wrench device 102A of FIG. 1, according to an embodiment of the present disclosure. As illustrated, the ratcheting flex-wrench device 102A may include an elongated handle 104 having opposing ends 106, each opposing end 106 having an integral yoke 108 with a tool head 110 pivotally coupled to the integral yoke 108, as shown. The elongated handle 104 may include gripping surfaces configured to assist the gripping and handling of the ratcheting flex-wrench device 102A by the user.

The tool head 110 may include a housing 112 containing an annular socket member 114 rotationally disposed within the tool head 110 and may further house an internal ratchet mechanism 116 (not shown) configured to provide one-way directional rotation of the annular socket member 114. The annular socket member 114 functions as a fitting engager to engage a workpiece 109 having a Torx external hexalobular fitting (see again FIG. 1), also referred to herein as the external Torx head 107. When so engaged, the annular socket member 114 may be used to transfer torque forces applied at the handle 104 to the external Torx head 107 of the workpiece 109, thereby rotating the workpiece to enable removal, installation, or tightening.

A key feature of the present system is size and shape of the annular socket member 114, which includes internal contours 120 precisely matching the outer lobe contours of an external hexalobular fitting. More specifically, the annular socket member 114 is specifically configured to engage a Torx external hexalobular fitting, such as the external

Torx head 107 of the workpiece 109 shown in FIG. 1. The shape and dimensions of the Torx hexalobular format are well known, appearing in international standardization documents such as ISO 10664 published by the International Organization for Standardization. Unlike prior “universal” wrench devices designed to fit multiple fastener shapes, the annular socket member 114 is design specifically for the E-Torx format, thus providing a significantly larger contact area between the tool head 110 and the lobe surfaces of the E-Torx fitting during use. This results in a more efficient transfer of torque resulting in reduced fastener damage and extended tool life.

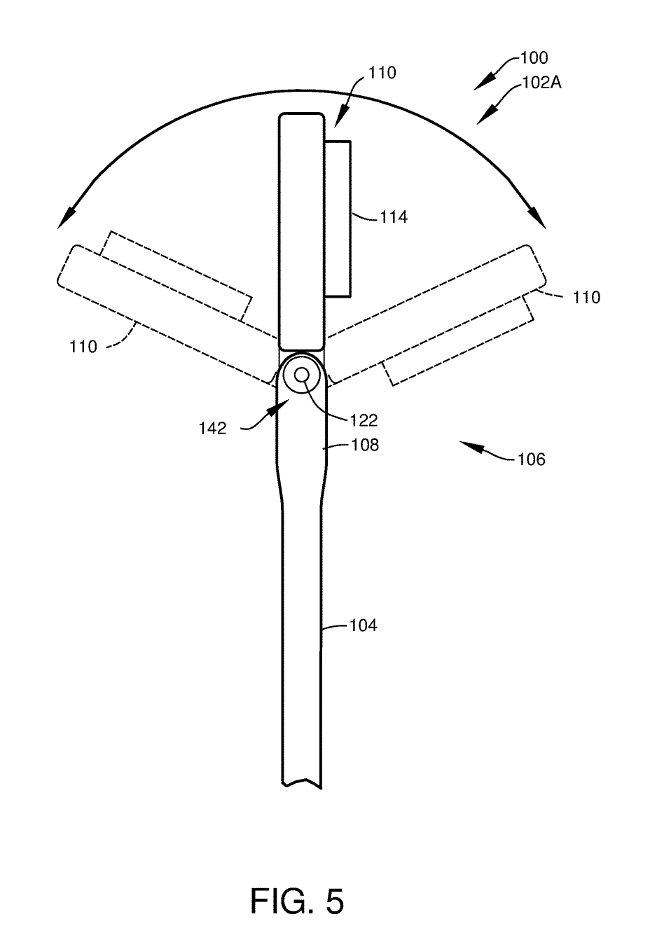

FIG. 5 is a partial side view of the ratcheting flex-wrench device 102A of FIG. 1, illustrating the pivot-adjustment feature of the tool head 110. In the presently-disclosed embodiments of the present system, the tool head 110 is attached to the handle 104 by a pivot bolt 122 such that the angle of the tool head 110 may be adjusted about the pivot axis 142, defined by pivot bolt 122. This permits the user to selectively adjust the angular position of the tool head 110 relative to the handle 104 to assist in reaching difficult-to-access fasteners.

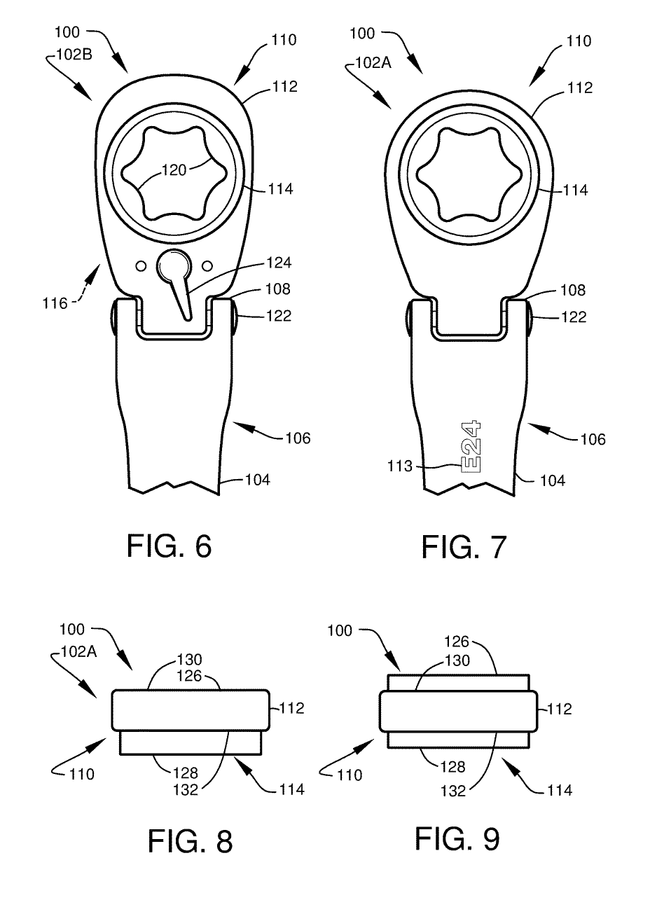

FIG. 6 is a partial front view of an alternate ratcheting flex-wrench device 102B of the ratcheting flex-wrench system 100, according to another embodiment of the present disclosure. The internal ratchet mechanism 116 of the alternate ratcheting flex-wrench device 102B may include a switch mechanism controlled by an external switch 124 enabling user-actuated reversals of the one-way directional rotation of the annular socket member 114. The internal ratchet mechanism 116 of the disclosed embodiments may be of several well-known designs configured to provide one-way directional rotation of the annular socket member 114. Such ratchet mechanisms may utilize, for example, an internal pawl automatically or selectively- engaging a gear wheel of the annular socket member 114. Those with ordinary skill in the art will now appreciate that upon reading this specification and by their understanding the art of ratchet mechanisms as described herein, that methods of implementing such ratchet mechanisms will be understood by those knowledgeable in such art.

FIG. 7 is a partial front view of the ratcheting flex-wrench device 102A of the ratcheting flex-wrench system 100, having a modified outer housing 112, according to an embodiment of the present disclosure. The modified E outer housing 112 of the alternate ratcheting flex-wrench device 102A may include a more rounded shape, as shown, to further assist in reaching difficult-to-access fasteners. Upon reading this specification, it should be appreciated that, under appropriate circumstances, considering such issues as user preferences, design preference, structural requirements, marketing preferences, cost, available materials, technological advances, etc., other housing arrangements such as, for example, alternate shapes, color coding to indicate sizes, etc., may be sufficient. In addition, the embodiments of the present system may include markings 113 indicating the size of the wrench, as shown.

FIG. 8 is a top view of the ratcheting flex-wrench device 102A of FIG. 1, according to an embodiment of the present disclosure. The annular socket member 114 has a first socket face 126 and a second socket face 128 opposite first socket face, as shown. The housing 112 of the tool head 110 has a first tool-head face 130 and a second tool-head face 132 opposite the first tool-head face, as shown. In one embodiment of the present system, at least one of the socket faces may be justified with the first tool-head face 130. In the illustration of FIG. 8, the first socket face 126 is justified with the first tool-head face 130, as shown.

In another embodiment of the present system, at least one of the socket faces project outwardly beyond the second tool-head face 132, as shown in FIG. 9. In the depiction of FIG. 9, both the first socket face 126 and the second socket face 128 extend outwardly beyond the first tool-head face 130 and the second tool-head face 132, as shown.

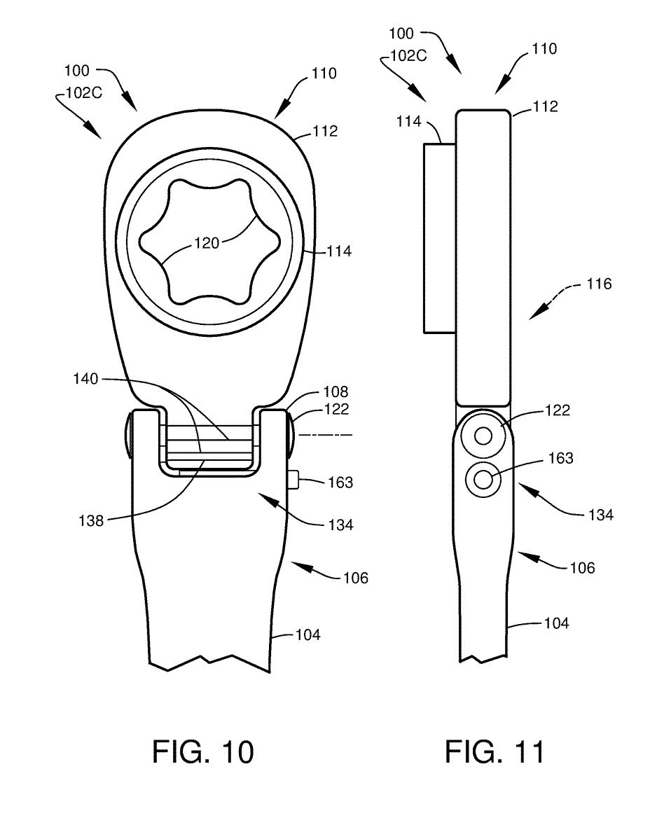

FIG. 10 is a partial front view of a locking ratcheting flex-wrench device 102C of the ratcheting flex-wrench system 100, according to another embodiment of the present disclosure. FIG. 11 is a partial side view of the locking ratcheting flex-wrench device 102C of FIG. 10, according to an embodiment of the present disclosure. Embodiments of the present disclosure may further include a head-angle retaining mechanism 134 configured to retain the tool head 110 at a user-selectable angular position relative to the handle 104.

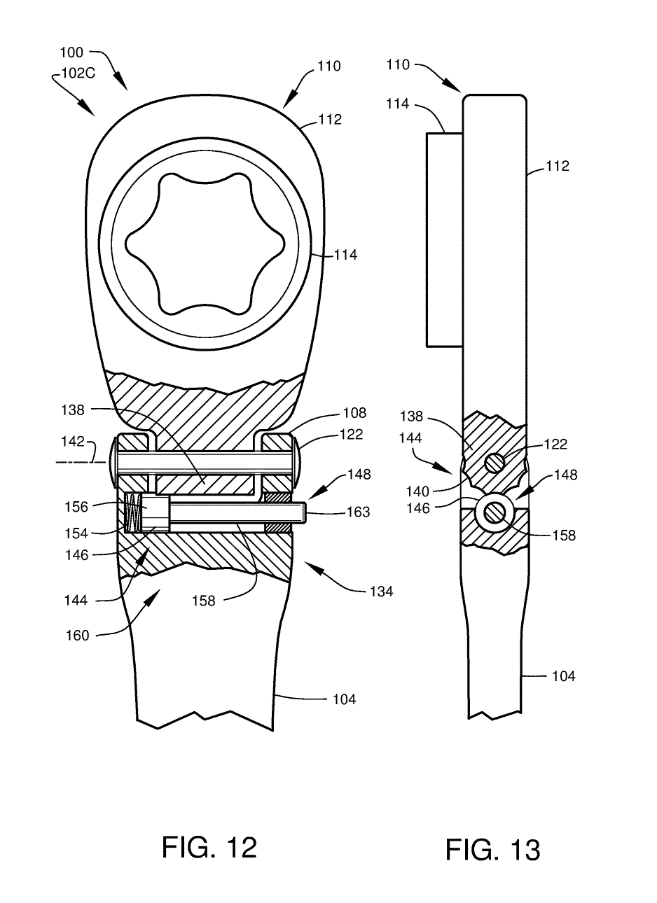

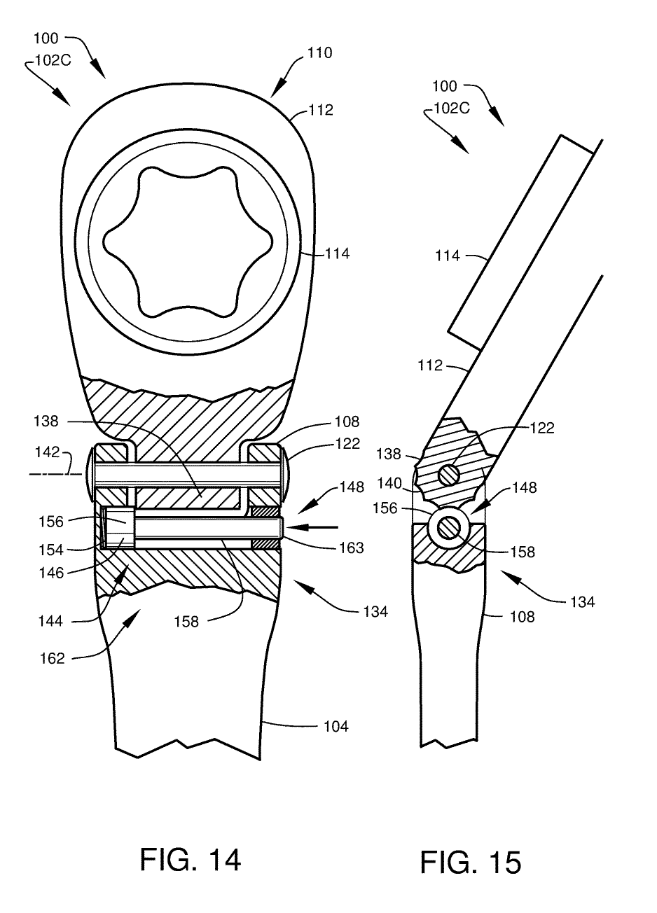

FIG. 12 is a front view, in partial section, of the locking ratcheting flex-wrench device 102C of FIG. 10 in a locked condition preventing pivoting of the tool head 110. FIG. 13 is a side view, in partial section, of the locking ratcheting flex-wrench device 102C of FIG. 10, according to an embodiment of the present disclosure. FIG. 14 is a front view, in partial section, of the locking ratcheting flex-wrench device 102C of FIG. 10 in an unlocked condition 136 according to an embodiment of the present disclosure. FIG. 15 is a side view, in partial section, of the locking ratcheting flex-wrench device 102C of FIG. 10 adjusted to a new tool-head angle, according to an embodiment of the present disclosure.

In the embodiment illustrated in FIG. 10 through FIG. 15, the head-angle retaining mechanism 134 includes a detent-engagement hub 138 formed integrally with the tool head 110, as shown. The detent-engagement hub 138 includes a plurality of arcuately-arranged grooves 140 oriented in substantially-parallel relationship with a pivot axis 142 of the tool head 110. A user-operable detent mechanism 144 disposed within the integral yoke 108, selectively locks and unlocks the pivoting feature of the tool head 110. More specifically, the user-operable detent mechanism 144 has a hub-engaging detent member 146 configured to engage the grooves 140 of the detent-engagement hub 138, as shown.

The head-angle retaining mechanism 134 of locking ratcheting flex-wrench device 102C includes a shouldered pin 148 slidably disposed in an axially-extending bore 150 within integral yoke 108, as shown. The axially-extending bore 150 includes a bore axis 152 in parallel orientation with the pivot axis 142 of the tool head, as shown. A biasing spring 154 may be disposed within the axially-extending bore 150 and operably engaged with the shouldered pin 148, as shown. The shouldered pin 148 includes an enlarged head portion 156 and an elongated tail portion 158 extending outwardly from the enlarged head portion 156. It is noted that the enlarged head portion 156 forms the above-noted hub-engaging detent member 146.

The biasing spring 154 is configured to bias the enlarged head portion 156 to the locked position 160 engaging the grooves 140 of the detent-engagement hub 138 (see FIG. 12). Manually depressing the user-actuated locking and release button 163 translates the shouldered pin 148 to the unlocked position 162 disengaging the enlarged head portion 156 from the grooves 140 and positioning the elongated tail portion 158 adjacent the detent-engagement hub 138. It is noted that the elongated tail portion 158 has a cross-sectional dimension smaller than that of the enlarged head portion 156. This allows the detent-engagement hub 138 to freely pass over the elongated tail portion 158 when the pin is moved to the unlocked position 162 of FIG. 14.

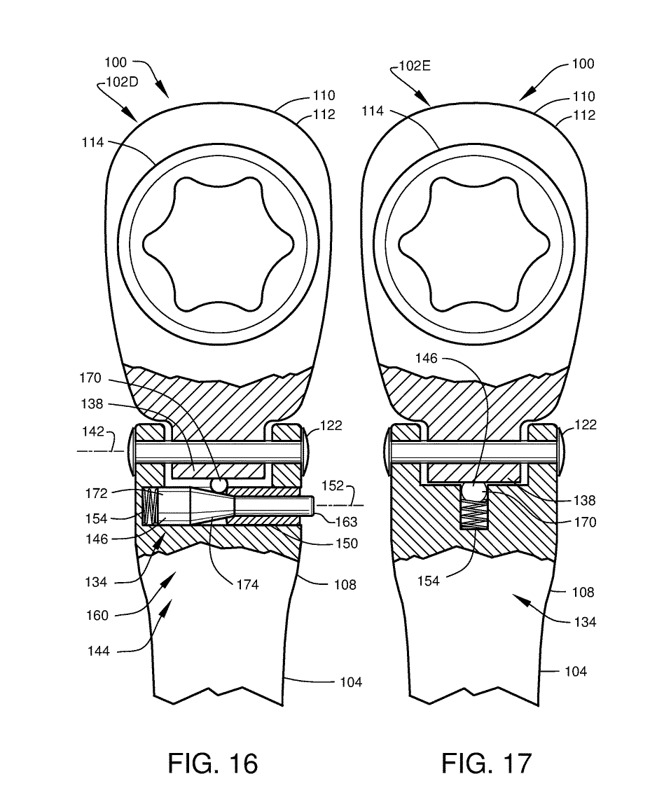

FIG. 16 is a front view, in partial section of an alternate locking ratcheting flex-wrench device 102D of the ratcheting flex-wrench system 100, according to another embodiment of the present disclosure. In this embodiment, the head-angle retaining mechanism 134 includes a spherical detent 170 movably positioned adjacent the detent-engagement hub 138, a push bar 172 slidably disposed in an axially-extending bore 150 of the integral yoke 108, and a biasing spring 154 disposed within the axially-extending bore 150 and operably engaged with the push bar 172, as shown. The push bar 172 includes a sloping wall portion 174 extending axially along the push bar 172 and arrange to be in contact with the spherical detent 170, as shown. In this embodiment, the spherical detent 170 functions as the hub-engaging detent member.

The biasing spring 154 is configured to bias the sloping wall portion 174 to a position urging the spherical detent 170 to the locked position 160 engaging the grooves 140 of the detent-engagement hub 138, as shown. Manually depressing the user-actuated locking and release button 163 translates the push bar 172 to locate the sloping wall portion 174 in a position allowing the spherical detent 170 to drop to an unlocked position disengaging the spherical detent 170 from the grooves 140. In this embodiment, the axially-extending bore 150 has a bore axis 152 in parallel orientation with the pivot axis 142 of the tool head 110, as shown.

FIG. 17 is a front view, in partial section of an alternate locking ratcheting flex-wrench device 102E of the ratcheting flex-wrench system 100, according to another embodiment of the present disclosure. In this embodiment, the hub-engaging detent member 146 includes a spherical detent 170 having a biasing spring 154 configured to bias the spherical detent 170 to a position releasably engaging the grooves 140 of the detent-engagement hub 138. In this version, the position of the head 110 is held by friction only, which may be preferred in some applications.

According to another embodiment of the present system, the ratcheting flex-wrench system 100 may be arranged as a kit 105, as generally shown in FIG. 1. The kit 105 may include a plurality of ratcheting flex-wrench devices each one including a pair of annular socket members 114 having sizes differing from the other wrenches of the kit 105. The plurality of ratcheting flex-wrench devices of the kit 105 may comprise sizes ranging between E4 and E44. The kit 105 may further include a set of instructions 155. The instructions 155 may detail functional relationships in relation to the structure of the ratcheting flex-wrench system 100 (such that the ratcheting flex-wrench system 100 can be used, maintained, or the like, in a preferred manner). Upon reading this specification, it should be appreciated that, under appropriate circumstances, considering such issues as user preferences, design preference, structural requirements, marketing preferences, cost, available materials, technological advances, etc., other size arrangements such as, for example, smaller or larger sizes, custom and non-standard sizes, other external hexalobular formats, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ratcheting flex-wrench device, the device comprising:
an elongated handle having opposing ends, each opposing end having
an integral yoke,
a tool head pivotally coupled to the integral yoke, the tool head including
an annular socket member rotationally disposed within the tool head, the annular socket member configured to engage a Torx external hexalobular fitting of a workpiece, the annular socket member having internal contours matching the outer lobe contours of the Torx external hexalobular fitting and enabling a transfer of force between the tool head and the lobe surfaces of the Torx external hexalobular fitting; and
a ratchet mechanism configured to provide one-way directional rotation of the annular socket member.

2. The ratcheting flex-wrench device of claim 1, wherein the ratchet mechanism includes a switch mechanism enabling user-actuated reversals of the one-way directional rotation of the annular socket member.

3. The ratcheting flex-wrench device of claim 1, wherein the annular socket member is configured to engage a Torx external hexalobular fitting having a standard size of between E4 and E44.

4. The ratcheting flex-wrench device of claim 1, wherein
the annular socket member has a first socket face and a second socket face opposite first socket face;
the tool head has a first tool-head face and a second tool-head face opposite the first tool-head face; and
at least one of the first socket face and the second socket face are justified with the first tool-head face.

5. The ratcheting flex-wrench device of claim 4, wherein at least one of the first socket face and the second socket face project outwardly beyond the second tool-head face.

6. The ratcheting flex-wrench device of claim 1, further comprising
a head-angle retaining mechanism configured to retain the tool head at a user-selectable angular position relative to the elongated handle;
wherein the head-angle retaining mechanism comprises
a detent-engagement hub integral with the tool head, the detent-engagement hub having a plurality of arcuately-arranged grooves oriented in substantially-parallel relationship with a pivot axis of the tool head, and
a user-operable detent mechanism disposed within the integral yoke, the user-operable detent mechanism having a hub-engaging detent member configured to engage the grooves of the detent-engagement hub.

7. The ratcheting flex-wrench device of claim 6, wherein the hub-engaging detent member comprises a spherical detent having a biasing spring configured to bias the spherical detent to a position releasably engaging the grooves of the detent-engagement hub.

8. The ratcheting flex-wrench device of claim 6, wherein the user-operable detent mechanism comprises
interoperating with the hub-engaging detent member, a user-actuated locking and release button configured to move the hub-engaging detent member between a locking position engaging the grooves and an unlocked position disengaged from the grooves;
wherein the pivotal rotation of the tool head relative to the elongated handle is prevented when the hub-engaging detent member is in the locked position; and
wherein the pivotal rotation of the tool head relative to the elongated handle is enabled when the hub-engaging detent member is in the unlocked position.

9. The ratcheting flex-wrench device of claim 8, wherein the head-angle retaining mechanism further comprises
a shouldered pin slidably disposed in an axially-extending bore of the integral yoke; and
a biasing spring disposed within the axially-extending bore and operably engaged with the shouldered pin;
wherein the shouldered pin includes an enlarged head portion and an elongated tail portion extending outwardly therefrom;
wherein the enlarged head portion forms the hub-engaging detent member;
wherein the elongated tail portion has a cross-sectional dimension smaller than that of the enlarged head portion;
wherein the biasing spring is configured to bias the enlarged head portion to the locked position engaging the grooves of the detent-engagement hub; and
wherein manually depressing the user-actuated locking and release button translates the shouldered pin to the unlocked position disengaging the enlarged head portion from the grooves and positioning the elongated tail portion adjacent the detent-engagement hub.

10. The ratcheting flex-wrench device of claim 9, wherein the axially-extending bore comprises a bore axis in parallel orientation with the pivot axis of the tool head.

11. The ratcheting flex-wrench device of claim 8, wherein the wherein the head-angle retaining mechanism further comprises
a spherical detent movably positioned adjacent the detent-engagement hub;
a push bar slidably disposed in an axially-extending bore of the integral yoke; and
a biasing spring disposed within the axially-extending bore and operably engaged with the push bar;
wherein the push bar includes a sloping wall portion extending axially along the push bar and arrange to be in contact with the spherical detent;
wherein the spherical detent comprises the hub-engaging detent member;
wherein the biasing spring is configured to bias the sloping wall portion to a position urging the spherical detent to the locked position engaging the grooves of the detent-engagement hub; and
wherein manually depressing the user-actuated locking and release button translates the push bar to locate the sloping wall portion in a position allowing the spherical detent to move to the unlocked position disengaging the spherical detent from the grooves.

12. The ratcheting flex-wrench device of claim 11, wherein the axially-extending bore comprises a bore axis in parallel orientation with the pivot axis of the tool head.

13. A ratcheting flex-wrench device, the device comprising:
a handle having opposing handle ends, each handle end comprising
a tool head pivotally coupled to the handle, the tool head including
an annular socket member rotationally disposed within the tool head, the annular socket member configured to engage a Torx external hexalobular fitting of a workpiece, the annular socket member having internal contours matching the outer lobe contours of the Torx external hexalobular fitting and enabling a transfer of force between the tool head and the lobe surfaces of the Torx external hexalobular fitting;
a ratchet mechanism configured to provide one-way directional rotation of the annular socket member;
a head-angle retaining mechanism configured to retain the tool head at a user-selectable angular position relative to the handle;
wherein the head-angle retaining mechanism comprises
a detent-engagement hub integral with the tool head, the detent-engagement hub having a plurality of arcuately-arranged grooves oriented in substantially-parallel relationship with a pivot axis of the tool head;
a user-operable detent mechanism disposed within the handle end, the user-operable detent mechanism having
a hub-engaging detent member configured to engage the grooves of the detent-engagement hub, and
interoperating with the hub-engaging detent member, a user-actuated locking and release button configured to move the hub-engaging detent member between a locking position engaging the grooves and an unlocked position disengaged from the grooves;
wherein the pivotal rotation of the tool head relative to the handle is prevented when the hub-engaging detent member is in the locked position; and
wherein the pivotal rotation of the tool head relative to the handle is enabled when the hub-engaging detent member is in the unlocked position.

14. The ratcheting flex-wrench device of claim 13, wherein the ratchet mechanism includes a switch mechanism enabling user-actuated reversals of the one-way directional rotation of the annular socket member.

15. The ratcheting flex-wrench device of claim 13, where the ratcheting flex-wrench device is arranged as a kit, the kit comprising a plurality of ratcheting flex-wrench devices each one comprising a size differing from the others.

16. The ratcheting flex-wrench device of claim 15, wherein the plurality of ratcheting flex-wrench devices comprise sizes ranging between E4 and E44.

17. A ratcheting flex-wrench device, the device comprising:
a handle having two opposing ends, the handle configured to assist user handling of the ratcheting flex-wrench device, each opposing end comprising
a fitting engager configured to engage a Torx external hexalobular fitting of a workpiece, the fitting engager assisting the transfer torque forces between the handle and the workpiece,
a housing configured to house the fitting engager,
a ratchet mechanisms providing one-way directional rotation of fitting engager within the housing;
a pivot coupler configured to pivotally couple the housing to the handle; and
a head-angle retainer configured to retain the housing at a user-selectable angular position relative to the handle.

18. The ratcheting flex-wrench device of claim 17, wherein the head-angle retainer comprises a releasable lock configured to releasably lock the housing in a user-selectable angular position relative to the handle.

19. The ratcheting flex-wrench device of claim 18, wherein the releasable lock comprises
a detent-engagement hub integral with the housing, the detent-engagement hub having a plurality of arcuately-arranged grooves oriented in substantially-parallel relationship with a pivot axis of the housing; and
a user-operable detent mechanism disposed within the handle, the user-operable detent mechanism having a hub-engaging detent member configured to engage the grooves of the detent-engagement hub.

20. The ratcheting flex-wrench device of claim 17, wherein the ratchet mechanism includes a switch mechanism enabling user-actuated reversals of the one-way directional rotation of the annular socket member.
